(19) United States
(12) Patent Application Publication
(10) Pub. No.: US 2011/0173443 A1
(43) Pub. Date: Jul. 14, 2011

(54) SECURE EXTRANET SERVER

(75) Inventors: CYRILL OSTERWALDER, DACHSEN (CH); FRIEDRICH CLAUDE OESCH, SCHOTTIKON (CH)

(73) Assignee: PHION AG, INNSBRUCK (AT)

(21) Appl. No.: 12/685,708

(22) Filed: Jan. 12, 2010

(51) Int. Cl. H04L 29/06; H04L 9/00

(52) U.S. Cl. 713/165; 713/168

(57) ABSTRACT

A Secure Extranet Server (SES) provides for secure and traceable communication and document exchange between a trusted network and an untrusted network by authenticated users. The SES includes a first partition in communication with the untrusted network and a second partition in communication with the trusted network. The second partition maintains a session table and is in communication with a user authentication and authorization module. Communication between the first and second partition is preferably initiated by a request from the second partition. Security tokens attached to messages provide constraint checking on user inputs, access to documents and servers within the trusted network, checkout and checkin of controlled documents, and a single sign-on capability for on-line applications as well as local applications operating on protected files at remote user computers.

### FIELD OF THE INVENTION

The present invention relates to the field of secured computer systems. Specifically, the present invention relates to a central gatekeeper that monitors and verifies all communication between a plurality of secured computer systems and an unsecured network.

### BACKGROUND OF THE INVENTION

The Internet provides connectivity to everyone on the net and allows businesses to reach many customers at very low transaction cost. Businesses may provide real-time information to the customer and allow the customer to review previous orders at a very low cost by allowing the customer to access the business database on the company's application servers. An extranet is a private network that uses Internet protocols, network connectivity, and possibly the public telecommunication system to securely share part of an organization's information, documents, or operations with suppliers, vendors, partners, customers or employees outside the organization's network. An extranet can be viewed as part of a company's intranet that is extended to users outside the company, usually via the Internet. However, shared documents and messages that pass into and out of a company's network to remote or mobile users on untrusted networks require protection.

The high connectivity of the Internet, however, also provides connectivity to attackers who may try to access, corrupt, or destroy network resources on the company's trusted network such as, for example, the company's mail server or the company's order/entry system, the company's internal research database, shared workspaces, collaboration servers, or the company's web server. In order to prevent such unauthorized access to the company network resources, application developers usually incorporate security modules into an application server controlling the network resource.

Large companies may have several application servers with each application server having a different security module protecting each application server. Each security module may have been developed by a different application developer or integrator and may not be accessible to the company's security administrator. The level of security provided by the application security module may vary according to the security expertise of the application developer. The numerous individual application server modules makes overall system security administration very difficult, if not impossible.

Another method for providing security for a trusted network is the use of a firewall between the trusted network and the un-trusted network. The firewall acts as a gatekeeper between the trusted and un-trusted networks by allowing or rejecting incoming (from the un-trusted network to the trusted network) data packets based on information contained in the packet header. U.S. Pat. No. 6,219,786 filed Sep. 9, 1998 (Cunningham patent) describes a firewall that uses the information contained in the lower levels of the seven layer network protocol stack to determine if an incoming packet should be allowed to pass into the trusted network. The Cunningham patent also discloses the use of information contained in the application layer to determine whether a message should be allowed into the trusted network by reassembling the data packets until sufficient information in the message is available to make a determination. Once allowed into the trusted network, however, the firewall does not check or enforce the action of the message within the trusted network. Furthermore, the firewall allows a direct connection that remains open between the user on the un-trusted network and the allowed trusted network resource for the duration of the session. The direct connection and the duration of the connection presents a security risk to the trusted network if the connection is hijacked by an attacker.

U.S. Pat. No. 6,289,462 filed Sep. 28, 1999 (McNabb patent) discloses a trusted operating system that enforces mandatory access control (MAC) by attaching sensitivity labels (SL) to each named object such as files, programs, and messages and enforces access restrictions to the named objects through a set of MAC rules. Each SL includes a classification and a compartment that the named object is allowed. Objects cannot access objects in different compartments nor objects with higher classifications except through the use of a security gate. A security gate is configured by the security administrator and is given a SL that is greater than either of the compartments connected by the security gate. The security gate remains open and allows a continuous message stream through the gate. Messages may be sent to other trusted systems over an untrusted network by attaching the SL to the message prior to transmission over the un-trusted network. The message and SL, however, are secure only within the operating system and cannot be enforced on a non-MAC operating system. Furthermore, an application server in the trusted network but running on a non-MAC operating system such as, for example, a legacy system, cannot enforce the SL of incoming messages.

Reshef et al U.S. Pat. No. 6.321,337 discloses two robots who access a proprietary private data format intermediate between an internal network and an external network. However documents and messages which pass out of the trusted network do not have encrypted security tokens which enable controlled documents to be modified and submitted back into a collaborative platform in the trusted network without multiple login and password transactions.

Therefore, there remains a need for a centralized security module that provides for a uniform and known level of security across all applications while providing for the distributed detection and elimination of hacking attempts, unauthorized messages, and document transfers between the secured computer system and the unsecured communication network.

### SUMMARY OF THE INVENTION

One aspect of the present invention is directed to a secure extranet server for restricted access to a resource on a trusted network from an untrusted network, the server comprising: an adapter for converting a message having a message protocol to and from an internal message having an internal message protocol different from the message protocol; a filter for verifying the contents of the internal message; a message application programming interface for transferring the internal message between the adapter and the filter; a session table configured to hold at least one characteristic of the internal message; a manager configured to maintain the session table based on a user authorization and the message; a converter for converting the internal message to and from a trusted message; and a dispatcher for receiving and forwarding the trusted message to the resource on the trusted network. Messages include attachments and electronic documents which are access controlled, version tracked and shared among users.

In another aspect of the invention, User Input elements and/or uniform resource identifiers (URIs) in a content description language (for example HTML) are passed through a secure extranet server. The secure extranet server is placed in front of Web application servers in order to protect the servers from hacking attempts. For validating URIs, user inputs or parameters of requests the content description language of the request is enriched by the secure extranet server with at least one additional security token that is dynamically created and based on the content being transferred. The user receives the enriched information and returns it with the user data input. Any secure extranet server can then verify all provided user input data against the constraints described in the security token. This solution guarantees that the information used for verifying the user input fits to the request to which the user input was sent.

### BRIEF DESCRIPTION OF THE DRAWINGS

The present invention may be understood more fully by reference to the following detailed description of the preferred embodiment of the present invention, illustrative examples of specific embodiments of the invention and the appended figures in which:

FIG. 1 is a block diagram of one embodiment of the present invention;

FIG. 2 is a flow diagram of the adapter processing an incoming message in a preferred embodiment of the present invention;

FIG. 3 is a flow diagram of the filter processing an incoming message in a preferred embodiment of the present invention;

FIG. 4 is a flow diagram of the Session & Trust (S&T) Manager processing an incoming message in a preferred embodiment;

FIG. 5 is a diagram showing a session entry in the session table in a preferred embodiment of the present invention;

FIG. 6 is an illustration of the message structures used in a preferred embodiment of the present invention; and

FIG. 7 is a flow diagram of the application programming interface for transferring messages between the external and internal partitions in a preferred embodiment of the present invention.

### DETAILED DISCLOSURE OF A PREFERRED EMBODIMENT

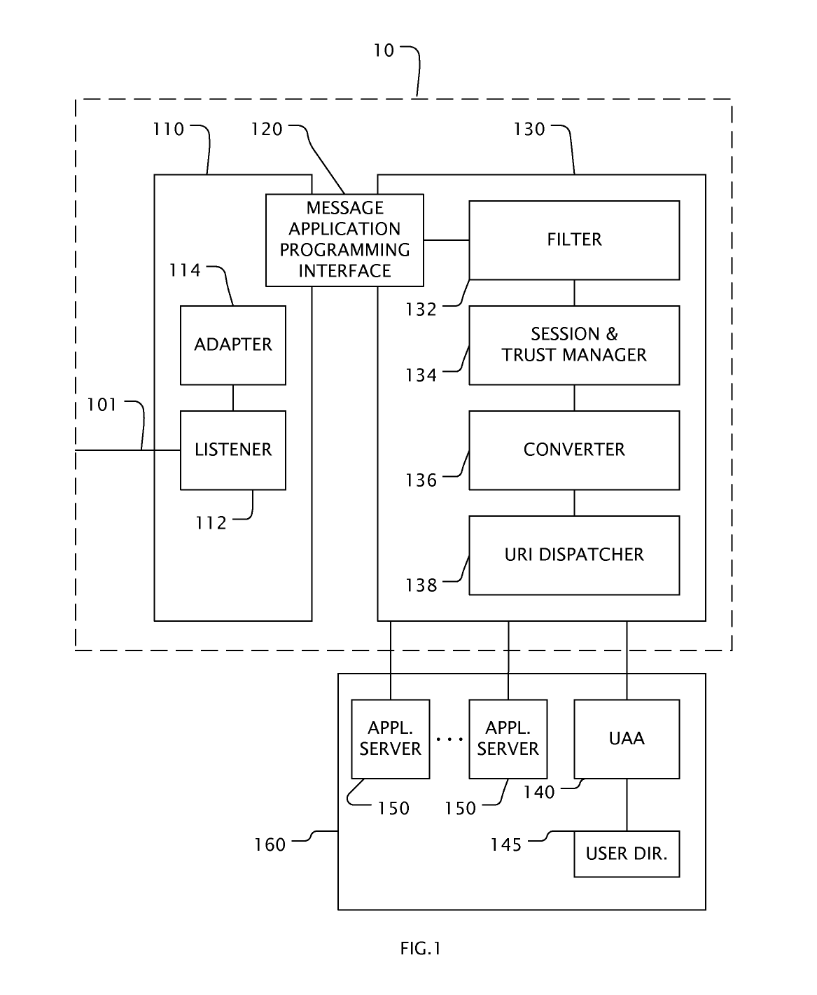

FIG. 1 is a block diagram of one embodiment of the present invention. The Secure Extranet Server (SES) 10 is preferably a computer program executing in a computer operating system (OS) environment. The computer program may be stored on any kind of computer-readable medium known to one of skill in the art such as, for example, floppy disks, hard disks, CD-ROMS, Flash ROMS, nonvolatile ROM, and RAM.

In an embodiment the SES 10 executes in two separate partitions 110, 130 maintained by the operating system. In an embodiment, the SES 10 executes in a plurality of processors communicatively coupled. In an embodiment the SES 10 executes in a plurality of virtual machines. In the preferred embodiment, the operating system enforces mandatory access control between the partitions 110, 130. In a preferred embodiment, each partition is characterized by a SL that includes both a compartment and a classification and each partition may contain several compartments. External partition 110 directly communicates with the untrusted network. Internal partition 130 directly communicates with the trusted network 160. Communication between the external partition 110 and the internal partition 130 is restricted to a message application programming interface 120 that allows only a single message to be passed between the partitions per request initiated by the internal partition 130. The external partition 110 cannot read or write to the internal partition 130 thereby preventing an attack into the trusted network even if the external partition 110 is compromised for any reason. In a preferred embodiment, all communication between the external partition 110 and the internal partition 130 is initiated by the internal partition 130 via a message application programming interface 120. In an alternate embodiment, the request to read or write to the message application programming interface 120 may be initiated by the external partition 110. The application programming interface 120 remains closed thereby preventing any communication between the external and internal partitions unless a request is initiated by the internal or external partition.

The internal partition 130 is in communication with the User Authentication & Authorization (UAA) module 140 and with at least one trusted resource 150 on the trusted network.

The SES 10 relieves each trusted resource 150 on the trusted network from handling the common security administration duties of access and authentication. As used herein, a resource on the trusted network is any network resource available to authorized users on the trusted network and may include collaboration servers, document control servers, application servers, mail servers, or the like. The SES 10 provides a uniform level of security for each trusted resource while providing for a centralized and separate security administration for the trusted network.

In an embodiment the external partition 110 has a listener 112 and an adapter 114. The listener 112 is connected to the communications link 101 and accepts incoming messages addressed to a trusted network resource and handles message encryption/decryption at the network (SSL) level. In an embodiment the adapter 114 verifies the message protocol, and reformats the incoming message into a common internal message (IM) having an Internal Message Format (IMF) that is different from the format, or protocol, of the incoming message. Reformatting or translating the message into an IM allows the SES 10 to handle any of the TCP/IP message protocols in a simple and secure manner.

The internal partition 130 includes a filter 132, a Session & Trust Manager (S&T Manager) 134, message converter 136, and a URL dispatcher 138. The filter 132 controls the message transfer between the external partition 110 and the internal partition 130 and performs a more detailed verification of the message. The S&T Manager 134 authenticates and attaches the proper security information to each message and to each document. The verified and accepted message is rebuilt or converted into the original protocol of the incoming message by the converter 136 before being sent to the URL dispatcher 138. The URL dispatcher 138 directs each message to the proper trusted resource 150.

Each component of the SES 10 is now described with reference to an incoming message. It should be apparent to one of skill in the art that each component is capable of performing the reverse operation on an outgoing message. Unless otherwise stated, it should be understood that a component that, for example, decrypts an incoming message originating from the untrusted network also encrypts the outgoing message.

The communications link 101 provides bidirectional communication between the SES 10 and the untrusted network.

The communications link 101 presents the continuous stream of data (message) to a listener 112 executing within the external partition 110. The listener 112 accepts messages addressed to a resource on the trusted network and handles message encryption/decryption at the network level (SSL). The listener 112 decrypts the accepted message according to standard security protocols such as SSL or TLS and forwards the decrypted message to the adapter 114. Conversely, outgoing messages are encrypted using the same security protocol.

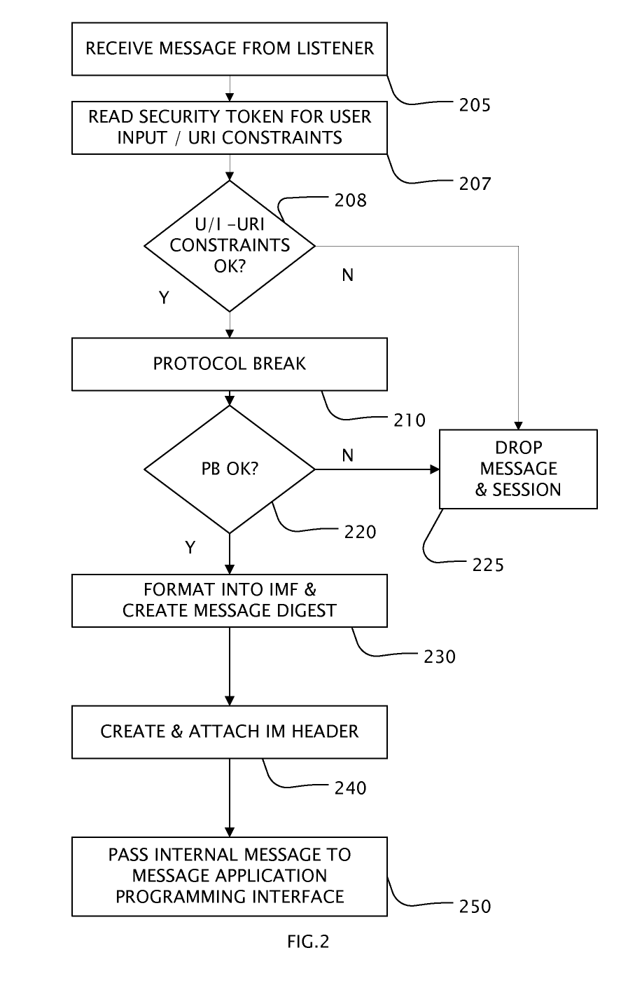

FIG. 2 is a flow diagram of the adapter processing an incoming message in a preferred embodiment of the present invention. In an embodiment the adapter 114 receives the message from the listener 112, reads a security token for each user input and for each uniform resource identifier (uri) which contains a constraint, 207 and performs a user input/uniform resource identifier constraint check 208 on the message. In an embodiment the adapter 114 receives the message from the listener 112 in step 210 and performs a protocol break 210 on the message. In protocol break 210, the adapter segments the header according to the network protocol of the message as known by one of skill in the networking art. The adapter checks the header information for self-consistency, proper syntax, and for valid field-names and field-values in step 220. If the adapter finds an invalid or disallowed field-name or field-value, or user input or uri which fails the constraint in the security token, the message and session is dropped in step 225.

The adapter also creates a message digest in step 230. The message digest is generated using techniques known to one of skill in the art and is used as a consistency check between the adapter 114 and filter 132. The message digest is a cryptographically secure hash function used in conjunction with a secret key to calculate a digital signature over the data.

The adapter generates an IM header in step 240 containing the verified field-names and field-values of the incoming message header along with the value length and type description. The message digest created in step 230 is also added to the IM header in step 240. The IM header contains control information such as, for example, the number of bytes in the internal message, message type, message protocol, protocol version, and the number of headers or name/value pairs.

The IM is passed to the application programming interface in step 250. The IM is used only within the SES 10. Only internal messages are passed between the internal partition 110 and external partition 130.

In one embodiment, the adapter 114 writes to an OS log. The adapter 114 writes the time and source of the message and any exceptions detected by the adapter. An exception occurs, for example, when the adapter 114 detects an unknown name in the message header or detects an invalid entry for the header tag. The OS log is maintained by the OS and permissions are set such that only the adapter 114 can write to the log.

The external partition 110 cannot read or write to the internal partition 130 and therefore cannot pass the IM to the internal partition 130. This restriction prevents a rogue program executing in the external partition 110 from writing into the internal partition 130 or from spawning a process into the internal partition 130. The IM is passed between the external partition 110 and the internal partition 130 based on actions initiated by the filter 132 in the internal partition 130.

In one embodiment, the filter 132 is assigned a specific privilege allowing the filter 132 to read and write internal messages in the external partition 110. The specific privilege, however, persists even when the filter is performing other operations that do not require such a privilege and may allow rogue programs executing in the internal partition to read or write to other partitions. Proper security practice, however, requires keeping security privileges restricted unless there is a need for a higher privilege and granting a higher privilege only when required and only for the duration of the existing requirement.

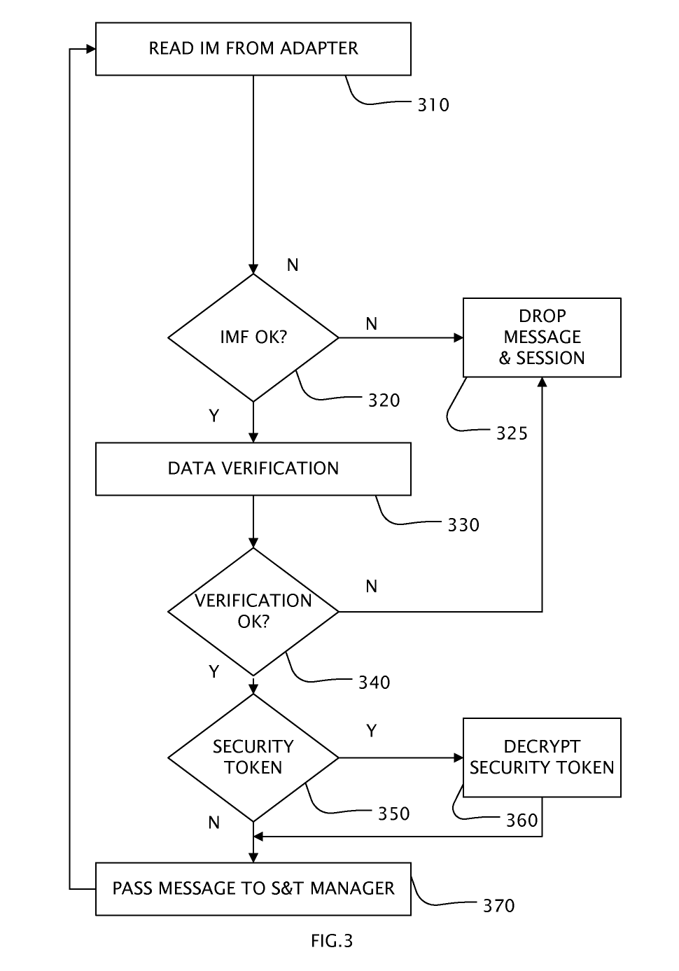

FIG. 3 is a flow diagram of the filter 132 for an incoming message in a preferred embodiment of the present invention. The filter reads a single IM from the adapter in step 310. The IM is passed between the external and internal partitions via the message application programming interface 120 by a request initiated by the filter 132 to the OS. The filter 132 sends a request to the OS to either read or write an IM in the external partition 110. The OS grants the request based on the SL of the filter allowing a single IM to be read by the filter (thereby allowing the IM to pass from the external partition to the internal partition) or to be written by the filter (thereby allowing the IM to pass from the internal partition to the external partition).

Once the filter 132 has read or written the IM, the filter 132 cannot read or write another message in the external partition 110 until another request is generated by the filter and granted by the OS. Although generating a request for each message reduces the throughput of the SES relative to a process that can freely read and write to the external partition, the performance reduction is insignificant when compared to the increased security resulting from strict enforcement of access between partitions.

The filter 132 verifies that the IM read from the external partition is in internal message format in step 320. The filter 132 determines the internal message length and compares the length to the length information stored in the IM header. The filter 132 also generates a message digest for the incoming message and compares the generated message digest to the message digest contained in the IMF header.

If the message fails any of the checks performed by the filter 132, the message and session are dropped in step 325 and the event logged to the internal log file.

If the message is in IMF, the filter 132 in step 330 may perform verification checks based on the content of the data. Unlike the syntax-type checks of the adapter 114, the filter's content-based checks may be used to restrict the universe of allowed information exchange between the untrusted and trusted networks in order to maintain the security of the trusted network. As an illustrative example, the filter 132 may check for a specific cookie (e.g. a cookie named LANGUAGE) and allow only a subset of allowed values (e.g. allow only “DE” and “EN” and disallow all others). The filter 132 may also perform different checks depending on the message protocol along with other self-consistency checks on the message. For example, an HTTP message must contain a non-empty URL and a GET or POST request must have a non-empty message field. The filter 132 may also enforce restrictions on the header values. For example, the filter 132 may restrict and enforce the maximum length of a parameter or require that the parameter consist of only characters or digits. Any inconsistencies are logged and the message and session dropped 325.

The filter 132, in step 350, checks for the presence of an security token in the message. If the filter detects an security token, the filter decrypts the security token in step 360 before the message is passed to the S&T Manager 134 in step 370.

For an outgoing message, the filter 132 receives the message from the S&T manager 134. The filter 132 performs a protocol break on the outgoing message header. The security token is signed, encrypted and appended to the outgoing message header. If the trusted resource 150 has attached an application cookie and the cookie is authorized to leave the trusted network, the filter encrypts and signs the application cookie. Encryption of the application cookies by the filter 132 has the advantage of providing a central location for managing the security task along with the other security duties of the SES 10 and provides for a uniform level of security for all the trusted resources on the trusted network.

The S&T Manager 134 verifies that the message is authorized to access a resource in the trusted network and maintains a persistent session with the user over the untrusted network. Session and resource access information are contained in a session table maintained by the S&T Manager 134. The persistent session enables an authorized user to download, modify, and submit a document under source code control and versioning without multiple sign in and reauthentication transactions.

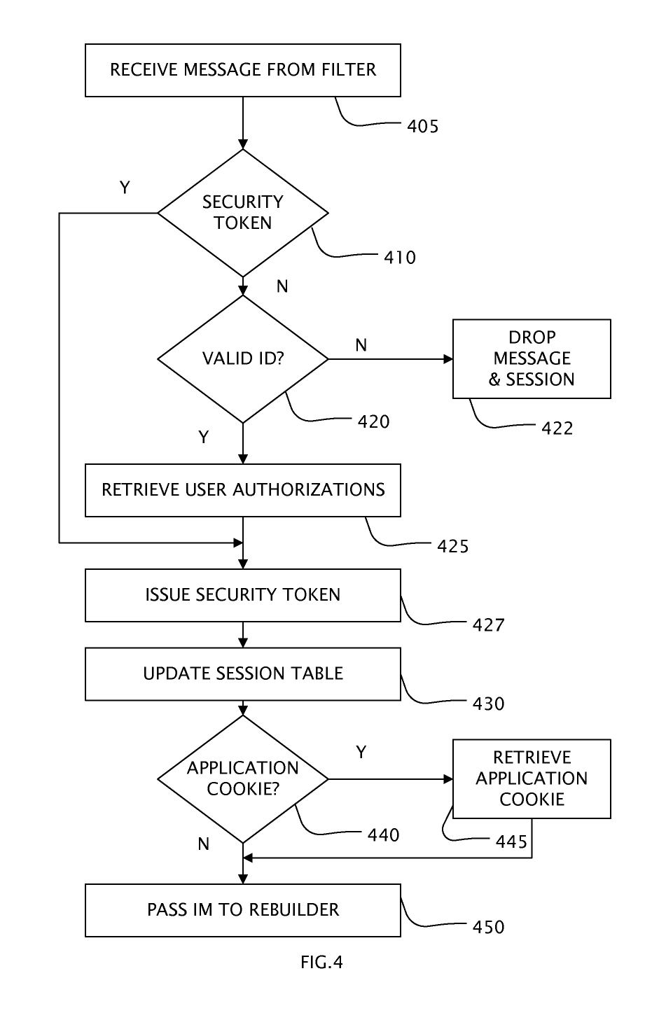

FIG. 4 is a flow diagram of the S&T Manager 134 for an incoming message in a preferred embodiment of the present invention. After receiving the incoming message from the filter 132 in step 405, the S&T Manager checks for an security token in step 410. If an incoming message does not have an security token, the S&T Manager 134 authenticates the identity of the user in step 420 using the User Authorization and Authentication (UM) module 140. The UM module 140 verifies the identity of the user using known authentication protocols such as, for example, passwords, tokens (such as SecurID and Vasco tokens), X509 PKI Certificates, or biometric data. The UM module 140 is configured to interface with a variety of user directories 145 provided by the trusted network administrator which may be different from the trusted network security administrator. The user directory 145 contains the list of authorized users, their passwords, and their network privileges and authorizations.

If the user cannot be authenticated, the S&T Manager drops the message and session 422. If the user is authenticated by the UAA, the S&T Manager retrieves the user's privileges and authorizations 425 from the UM and issues an security token in step 427. In a preferred embodiment, the security token is an index to the session table containing the session information.

The S&T Manager 134 updates the session table in step 430. The session table contains the information associated with each session and includes each user's role and authorizations. The S&T Manager further comprises an administration console for graphically authorizing access to various servers, applications, and document stores by selected untrusted networks.

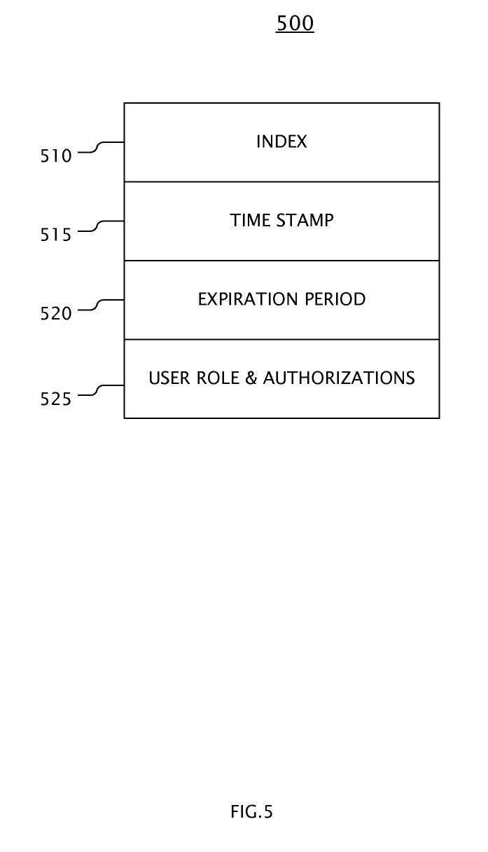

FIG. 5 is a diagram showing a session entry in the session table in a preferred embodiment of the present invention. Each entry 500 includes a session index 510, time stamp 515, expiration period 520, and user role information 525 provided by the UM module 140. The user role information may include all rights and permissions of the authenticated user and is available to all resources in the trusted network. Application cookies, if used by the trusted resource 150, are also included in the session table along with a flag indicating whether each application cookie may be passed to the untrusted network or removed from the message prior to entering the untrusted network.

The availability of the user's rights and permissions to the resources in the trusted network allows for dynamic authorization checking on the data level within the trusted resource 150 and relieves the trusted resource 150 of the burden of performing the authentication and authorization checks. Placing the responsibility of authentication and authorization on the S&T Manager 134 instead of the requested trusted resource further isolates and protects the resource from potentially harmful messages and provides a central and uniform level of authentication and authorization for the trusted network. The user may have authorization to only one trusted resource and access to one trusted resource does not necessarily grant access to the other resources on the trusted network.

In one embodiment, the security token is attached to the message and is used by the uniform resource identifier (URI) dispatcher 138 to direct the message to the authorized trusted resource 150. In another embodiment, the S&T Manager 134 passes the message to the URL dispatcher 138 along with an index to an internal session table that contains the address of the message's authorized trusted resource 150. The internal session table is controlled and maintained by the S&T Manager 134 in step 430 but may be read by the URL dispatcher 138 and filter 132.

In an embodiment the S&T Manager 134 creates or edits an security token. The security token is viewable to all resources on the trusted network and to certain applications running on the user's trusted computer on the untrusted network. In a preferred embodiment, the security token is signed and encrypted by the filter 132 before leaving the trusted network. In one embodiment, the security token is a non-persistent session cookie for HTTP protocol messages that is only stored in the volatile memory of the user's computer and only persists while the user's browser is open. In another embodiment, the security token uses uniform resource indicator (URI) rewriting wherein the signed and encrypted security token is appended as a character string to the message's URI address. In another embodiment, the security token is associated with a document in a collaboration or document management system.

The S&T Manager 134 monitors all security sensitive events in the internal partition and logs such events to a write-only internal log file maintained by the OS. Alternatively, the log information may be transferred to a log host on the trusted network. The internal log file is distinct and separate from the external log file written by the adapter 114. The S&T Manager 134 may log all or some of the information associated with an individual request such as, for example, time of request, IP number, DNS name, Security token, Application Server, Application Cookies, or content. All security alerts are logged by the S&T Manager 134. For example, if the S&T Manager 134 determines that the security token has been tampered, the message and session is dropped and an alert is logged in the internal log file.

The S&T Manager 134 may be configured to keep application level cookies within the trusted network in order to provide a higher security environment for the trusted network. The S&T Manager 134 checks the session table to see if an application cookie is associated with the message or session in step 440. If an application cookie is associated with the message, the S&T Manager 134, in step 445, retrieves and attaches the appropriate application cookie to the message. Conversely, if an outgoing message contains an application cookie that should not leave the trusted network, the S&T Manager will remove the application cookie from the outgoing message, store the application cookie and update the session table. Alternatively, the S&T Manager may encrypt the application cookie attached to the outgoing message to prevent the user, or others, from viewing the contents of the application cookie The S&T Manager 134 removes the application level cookie from the outgoing message and reattaches the cookie to an incoming message according to the security token attached to the message. The trusted resource is not aware that the S&T Manager is managing the application cookie and therefore does not require customization for security environments prohibiting application cookies over untrusted networks.

Before the IM is forwarded to the trusted network by the dispatcher 138, the IM is converted to a protocol supported by the requested trusted resource by the converter 136. In most cases, the converter 136 converts the IM to the protocol of the incoming message such that, for example, an incoming message in a POP3 protocol will have its IM converted to a POP3 protocol before being sent to the dispatcher 138. In some situations, however, the converter may convert the internal message to a protocol different from the incoming message protocol. This may occur, for example, if the requested trusted resource does not support the original protocol of the incoming message. For example, if the requested trusted resource only supports HTTP 1.0, the converter 136 will convert the IM to an HTTP 1.0 message even if the original protocol of the incoming message was in HTTP 1.1. Such exceptions may be set by the SES administrator and maintained by the converter 136. The converter 136 reconstructs the original protocol of the message based on the content of the IM. Conversely, the converter 136 also converts an outgoing message to an IM.

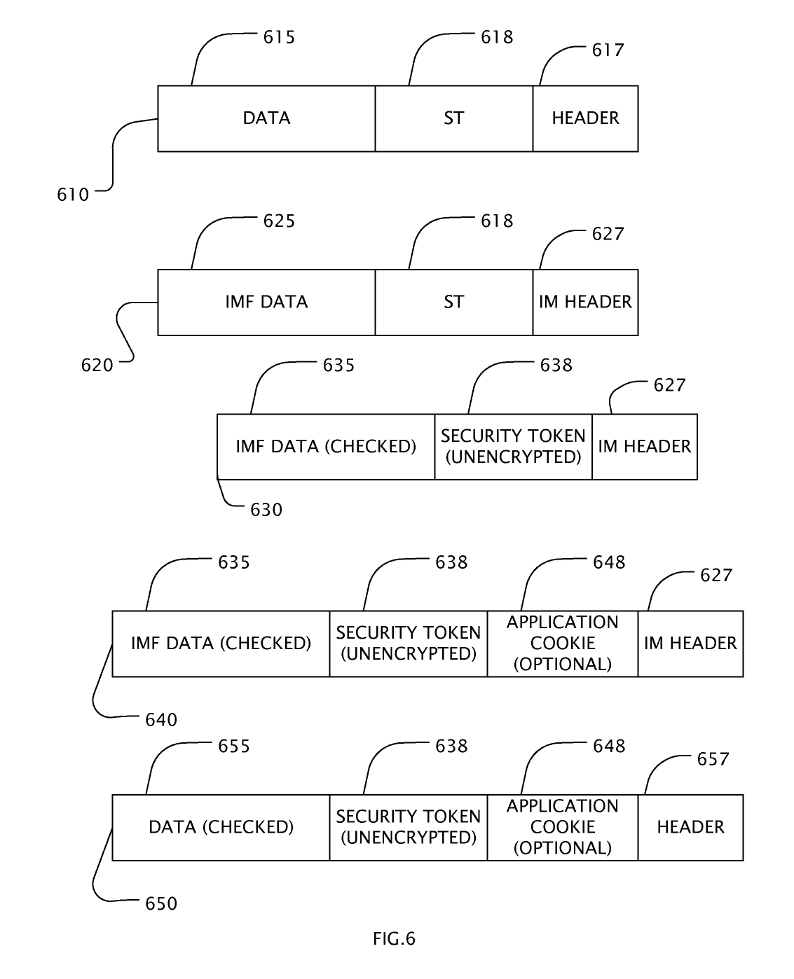

FIG. 6 shows the message structures at various points in the SES. Incoming message 610 is the message received from or transmitted to the un-trusted network. Incoming message 610 includes data 615 and a message header 617. Data 615 is preferably encrypted. Message header 617 includes information about the data such as type and length. The message header 617 may also include an encrypted security token 618 if the message is part of an opened session or transmits a document controlled by a document management system. In one embodiment, the security token 618 is implemented as a session cookie and incorporated into the HTTP header, for example. In another embodiment, the security token may be encoded into the URI.

Internal message (IM) 620 includes IMF data 625, security token 618, IM header 627. IMF data 625 and IM header 627 are based on the information provided by the message data 615 and message header 617 but are formatted in the IMF. Only messages having the IM structure are transferred between the external and internal partitions of the SES. The adapter 114 in the external partition converts or reformats an incoming message 610 to an IM 620 or coverts or reformats an outgoing IM to an outgoing message. The filter 132 in the internal partition reads the incoming IM from the external partition or writes the outgoing IM to the external partition.

The IM header 627 is appended to the IMF data 625 and contains the verified names and values of the message header 617 along with control information such as a time stamp, number of name-tag headers, and the length of the message.

The filter creates a verified message structure 630 before passing the verified message to the S&T Manager. The filter checks for the presence of an security token 618 and if present, decrypts and appends the decrypted security token 638 to the modified message structure 630. The filter also verifies the information contained in the IMF header 627 complies with the internal message format. The filter checks the data 635 for consistency with the verified header information.

The S&T Manager adds applicable application cookies 648 to the message 640 and updates the security token 638 before forwarding the message 640 to the converter 136.

The converter 136 converts the IM 640 to a trusted network message 650 according to the protocol of the incoming message 610. The important difference between the trusted message 650 and the incoming message 610 is that the data and header information in the trusted network message 640 are verified and consistent with each other and contain only the headers allowed by the trusted network. The incoming message 610 includes an encrypted security token 618 to prevent viewing or tampering of the security token in the un-trusted network. In contrast, the trusted network message 640 includes an un-encrypted security token 638 to allow the trusted network resources to use the information contained in the security token to grant varying levels of privileges and access rights to the trusted network resource. The trusted network message 650 may also include one or more of an application level cookie 648 that is available only to the specific trusted resource issuing the application level cookie 648.

The incoming message 610 and trusted network message 650 are formatted to comply with any of several known network protocols such as the TCP/IP family of protocols known to one of skill in the networking art. For example, if the incoming message is an HTTP message, the corresponding trusted network message will also follow the HTTP protocol. If the incoming message is a POP3 message, the corresponding trusted network message will follow the POP3 protocol. In contrast, messages 620, 630, and 640, generally referred to as an internal message, follow the internal message protocol of the SES, regardless of the protocol of the incoming message. The internal message allows the SES components to access the internal message data and header fields without knowing the protocol of the incoming message. Furthermore, additional protocol functionality may be added to the SES by simply adding a protocol-specific converter to the SES.

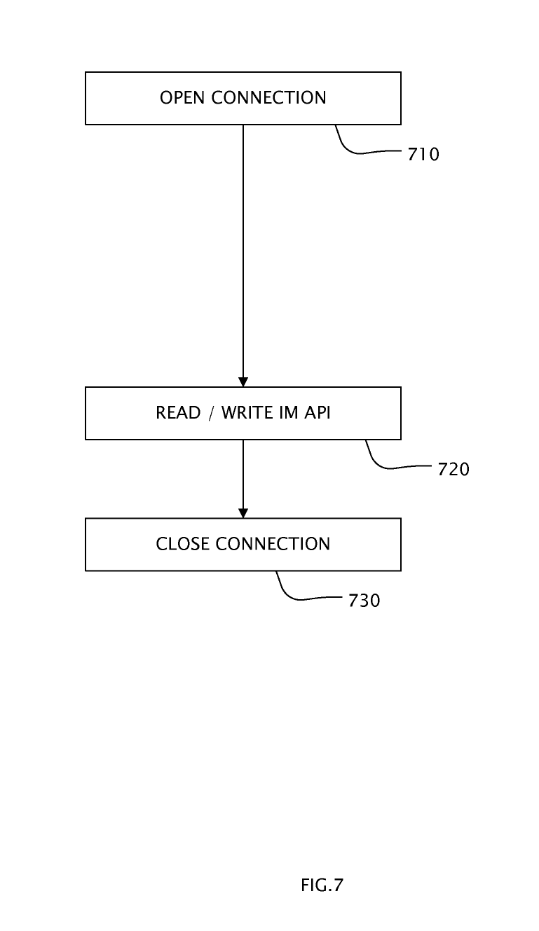

FIG. 7 is a diagram of secure application programming interface for transferring messages between the external and internal partitions in a preferred embodiment of the present invention. The isolation of the external partition 110 from the internal partition 130 provides an important security barrier for the SES 10 by confining any rogue process in the external partition 110 from spawning a process in the internal partition 130. Valid messages, however, must be able to cross between the external and internal partitions. Furthermore, the logical connection between the internal and external partition should only be open when a message must pass between the partitions and closed at other times. As used herein, it should be understood by one of skill in the art that an open logical connection means that the filter may read (or write) a message from the external partition and a closed logical connection means that the filter is prohibited from reading (or writing) a message from the external partition. Referring to FIG. 7, the application programming interface operates by first opening a logical connection between the external partition and internal partition in step 710. In a preferred embodiment, only the internal partition may initiate the request to open the logical connection. In an alternate embodiment, the external partition may initiate the request to open the logical connection. The request is made to the secured operating system as known by one of skill in the art. Once the logical connection is open, the filter reads a single IM from the adapter or writes a single IM to the adapter in step 720. After the IM is read from or written to the adapter, the filter issues a second request to the secured operating system to close the logical connection between the partitions in step 730 thereby preventing the filter from reading another message until a new request is initiated. The open logical connection between the internal and external partition presents a security risk that a rogue message could pass between the partition. Therefore, the logical connection is open only long enough to allow a single message to pass between the internal and external partition.

### Other Exemplary Non-Limiting Embodiments

In addition, the SES 10 is capable of supporting the various network protocols such as TCP/IP (including protocols such as HTTP, XML, IIOP, POP3, IMAP, SOAP, JRMP, RMI, SNMP, XNTP, TELNET, FTP, MS Exchange, SSH, JDBC, ODBC, SAMBA, and SMTP, or the like), IPX, Sun-RPC, NetBEUI, or other network protocols as known to one of skill in the art.

The communications link 101 may be physical, such as for example, optical fiber, coaxial cable, or twisted pair. Alternatively, the link 101 may be wireless, such as for example, infrared, microwave, or radio. The communications link 101 carries an essentially continuous data stream in various network protocols. The data may be un-encrypted or encrypted according to security protocols such as the Secure Sockets Layer (SSL) protocol, the Secure Hypertext Transfer Protocol (SHTTP), or the Transport Layer Security (TLS) protocol. In a preferred embodiment, data is encrypted using known encryption schemes such as DES, RC4, RC5, IDEA, AES, RSA, or DH. In another embodiment, hardware encryption accelerators as known in the art are used to improve the overall performance of the encryption/decryption operation.

By way of illustration, the embodiment of the protocol break is now described in the context of a specific header containing a cookie. If the adapter finds the field-name representing a cookie in the message header, the adapter checks for the expected colon and for the existence of the required field-value. Furthermore, the adapter verifies that the required field value follows the expected syntax for the cookie. If the required field-value is missing or the field-value does not follow the expected syntax, the message and session are dropped in step 225. The protocol break allows the adapter to check that each field-name in the header is an allowed field-name under the message's protocol. In an embodiment, if the field-name is not part of the message's protocol, the message and the session are dropped.

In an embodiment, if the message header information is valid, the adapter constructs an Internal Message (IM) based on the information in the message header and message data. The information in the message header and message data are reformatted according to an internal message format (IMF). All messages accepted by the adapter, regardless of message's network protocol, are converted into the IM message protocol in an embodiment. Converting the incoming message to the IM message protocol serves three purposes. First, converting the incoming message to the IM message protocol provides another layer of security protection against protocol-specific attacks. Second, the components of the SES 10 are only required to understand the single IM message protocol used in the SES 10 instead of the various network protocols. All information relating to specific network protocols are handled by the adapter 114 and the converter 136. Third, the capability of the SES to handle new or different network protocols may easily be expanded by adding the network protocol-specific information to the adapter and converter.

The filter 132 may also restrict and enforce a subset of a protocol's commands. Using the POP3 protocol as an example, the filter 132 may disallow the command PASS to prevent transmission of mailbox passwords to the mail server in plaintext. Similarly, the filter 132 may examine the contents of an outgoing message and remove portions of the outgoing message that should not be sent to the client such as, for example, Javascript code or strings containing security sensitive information. These protocol-specific rules may be customized differently for each trusted network resource.

The SES 10 may be configured to support client application tunneling by a local authentication proxy on the user's computer. The local authentication proxy 10 provides for proper authentication of the user by requesting credentials such as, for example, username/password, client certificate, token, or biometric data from the user by creating a SSL connection to the SES 10. If the user provided credentials are accepted by the proxy, the proxy sets up a secure tunnel to transmit and receive data to the trusted resource over the tunnel.

All data transferred through the secure application tunnel may be checked and filtered at the content level by SES 10. The tunnel is not limited to HTTP protocols but may also support, for example, IMAP, POP3, and SMTP protocols. The secure application tunnel provides additional protection to the trusted resources because there is no direct connection between the user and the trusted resource.

Tunneling allows a user to run standard software products on the user's machine even if the software product does not support strong authentication. By way of example, suppose a mail server using the POP3 protocol is one of the resources on the trusted network. In order to access the mail server, the user running Microsoft Outlook® must provide strong authentication by entering a login, password, and a hardware token. The POP3 protocol does not support strong authentication so the mail client, in this example Outlook®, cannot provide the strong authentication. Strong authentication is provided by the local authentication proxy running on the user's machine. The user authenticates himself through the proxy and once the user is authenticated by the S&T Manager, the local proxy acts as the local mail server to Outlook®. The local proxy tunnels the mail protocol to the SES 10 over the secure SSL connection thereby allowing the SES 10 to provide secure communication between the untrusted network and the trusted network.

Another aspect of the present invention is directed to a method for accepting a message received from an untrusted network by a secure extranet server in communication with a trusted network, the message characterized by a message protocol and an security token, the method comprising the steps of: receiving the message in an external partition of the server; verifying the message protocol; verifying the security token; converting the message into an internal message, the internal message characterized by an internal message protocol; transferring the internal message to an internal partition of the server; verifying the protocol of the internal message; and accepting the message by the secure extranet server.

Another aspect of the present invention is directed to a secure extranet server for accepting a message received from an untrusted network, the message characterized by a message protocol, the secure extranet server in communication with a trusted network, the secure extranet server comprising: means for receiving the message in an external partition of the server; means for verifying the message protocol; means for verifying an security token; means for converting the message into an internal message, the internal message characterized by an internal message protocol; means for transferring the internal message to an internal partition of the server; means for verifying the protocol of the internal message; and means for accepting the message by the secure extranet server.

Another aspect of the invention is directed to a security token which is embedded by secure extranet server into the HTML code of a web page. The security token contains all necessary information to check against the user input or uniform resource identifier (URI) or parameter description later and is preferably encrypted and digitally signed. The client Web browser having received HTML content with a security token created in the first part of the method sends the security token together with requested information for which the security token was created—back to the secure extranet server. The input and the security token sent by the browser is parsed by the secure extranet server which decrypts and verifies the security token and extracts the input validation constraints that have been encrypted into the token (e.g.valid URIs, parameter names, parameter value types, parameter value ranges, etc). The secure extranet server checks the request and its parameters against the constraints of the security token and as a result, may react accordingly if constraints are violated. A similar reaction will be caused in case of a missing or a violated security token. The reaction can be blocking the request and/or notifying the administrator of the Web Application servers.

The invention provides a method for operating a secure extranet server to prevent hacking attacks on a first computer endpoint from a plurality of second computer endpoints without allowing access to the trusted network, the method comprising
a) receiving from a first computer endpoint content description language comprising at least one request for input data and at least one constrain to the expected input data,
b) enriching the content description language sent by the first computer endpoint with at least one security token that is based on the at least one request for input data and comprises at least one constraint to the expected input data,
c) sending to a second computer endpoint content description language enriched with the at least one security token,
d) receiving from the second computer endpoint input data together with the at least one security token,
e) parsing input data and the at least one security token sent by the second computer endpoint,
f) verifying the input data against the at least one constraint determined in the security token, and
g) blocking the transfer of input data which does not conform to the at least one constraint.

Another aspect of the present invention is directed to a computer-readable medium having computer-executable instructions for performing a method for accepting a message received from an untrusted network by a secure extranet server in communication with a trusted network, the message characterized by a message protocol and an security token, the method comprising the steps described in the foregoing disclosure.

Another aspect of the present invention is directed to a secure extranet server comprising: an external partition in communication with an untrusted network, the external partition configured to convert a message from the untrusted network to an internal message, the message comprising a data field and a message header, the message header comprises at least one characteristic of the message; an internal partition in communication with a trusted network; and a message application programming interface configured to pass the internal message between the external partition and the internal partition only upon a request originating from the internal partition.

Another aspect of the present invention is directed to a computer-readable medium having stored thereon a data structure for a secure extranet server comprising: a session table, an internal message data field containing data conforming to an internal message protocol, the data representing a message between an untrusted network and a trusted network, the message characterized by a message protocol different from the internal message protocol; and an internal message header field containing data representing the characterization of the message data field according to the internal message protocol.

Another aspect of the present invention is directed to a method for forwarding a message from an untrusted network to a resource on a trusted network, the message characterized by a message protocol, the method comprising the steps described in the foregoing disclosure.

Another aspect of the present invention is directed to a secure extranet server for forwarding a message from an untrusted network to a resource on a trusted network, the message characterized by a message protocol, the secure extranet server comprising: means comprising a processor adapted by software embodiments of the method comprising the steps described in the foregoing disclosure.

Another aspect of the present invention is directed to a computer-readable medium having computer-executable instructions for performing a method for forwarding a message from an untrusted network to a resource on a trusted network, the message characterized by a message protocol, the method comprising the steps described in the foregoing disclosure.

### Conclusion

The present invention is distinguished from conventional constraint checking of user inputs or uri by an application server or host computer by providing a dynamic self-checking token which is applied outside of the trusted network. Unlike firewalls that do not track messages once the message is allowed into the trusted network, the SES 10 tracks every message entering and leaving the trusted network by attaching an security token to each message. If the user is not authorized to use the requested trusted resource, the S&T Manager 134 logs the exception to a second log maintained by the OS and drops both the message and session. Furthermore, firewalls establish a connection between the user on the un-trusted network and a port on the application server and keeps the connection open during the length of the session. The SES, in contrast, never allows a direct connection between a user on the un-trusted network and a trusted network resource. Messages are passed between the trusted and un-trusted network only one at a time and access between the trusted and un-trusted network is open only when a single message is transferred.

Unlike a B1 OS wherein the OS controls access of named objects based only on the object's SL, the SES provides a higher level awareness of the trusted network resources and is capable of configuring and administering security policy at the application level in a uniform manner regardless of the type and number of resources on the trusted network. In particular, SES 10 does not require that all trusted network resources run on an Operating System supporting Mandatory Access Control (MAC) because information pointed to by the security token provides the necessary authentication and authorization information required by the trusted network resources.

In a preferred embodiment, the OS is a security enhanced operating system as defined in “Common Criteria for Information Technology Security Evaluation”, CCIMB-99-021, Version 2.1 dated August, 1999, herein incorporated by reference in its entirety. In another embodiment, the OS enforces B1 level Mandatory Access Control (MAC) as described in “Department of Defense Trusted Computer System Evaluation Criteria”, DoD 5200.28-STD dated Dec. 26, 1985. An example of a security enhanced system is the PitBull® software available from Argus Systems Group, Inc. of Savoy, Ill., that provides B1 class extensions for the Sun Solaris®, IBM AIX® and Linux® operating systems. In an alternative embodiment, the SES 10 may be executed on a non-security enhanced system such as, for example, the Linux® operating system.

The use of the IMF adds an additional level of security to the message because attacks based on the known message protocols such as HTTP, IMAP, etc. can be detected by the protocol break or foiled by the rearrangement of the message into an IMF. The only requirement of the IMF is that it is generally simple in the sense of having a small and clearly defined set of parameters and can be handled without risks of buffer overflows, or other vulnerabilities caused by the complexity of the different protocol formats as known to one of skill in the art. In one embodiment, each SES 10 may use a different IMF. In another embodiment, the IMF is set and controlled by the security administrator.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used.

The invention described and claimed herein is not to be limited in scope by the preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

A number of references are cited herein, the entire disclosures of which are incorporated herein, in their entirety, by reference for all purposes. Further, none of these references, regardless of how characterized above, is admitted as prior to the invention of the subject matter claimed herein.

What is claimed is:

1. A method for accepting a message received from an untrusted network by a secure extranet server in communication with a trusted network, the message characterized by a message protocol, the method comprising the steps of:
receiving the message in an external partition of the server;
verifying the message protocol;
checking constraints on the message provided in a security token;
converting the message into an internal message, the internal message characterized by an internal message protocol;
transferring the internal message to an internal partition of the server;
verifying the protocol of the internal message;
accepting the message by the secure extranet server;
attaching an security token to the internal message;
forwarding the accepted message to the trusted network based on the security token;
accessing documents and servers within the trusted network based on the security token; and
checkout and checkin of controlled documents using a single sign-on capability for on-line applications as well as local applications operating on protected files at remote user computers.

2. The method of claim 1 further including after the step of attaching, the step of formatting the internal message according to the message protocol of the received message.

3. The method of claim 1 wherein the step of verifying the message protocol comprises the step of
verifying an attached security token if the message is part of an ongoing session.

4. The method of claim 1 wherein the step of verifying the message protocol includes the step of
dropping the message if the message does not conform to the message protocol.

5. The method of claim 1 wherein the step of verifying the internal message protocol includes the step of
dropping the internal message if the internal message does not conform to the internal message protocol.

6. A method for sending a message to an untrusted network by a secure extranet server in communication with a trusted network, the message characterized by a message protocol, the method comprising the steps of:
receiving the message in an internal partition of the server;
extracting attribute information on valid user inputs;
creating at least one security token that is based on the extracted attribute information;
converting the message into an internal message, the internal message characterized by an internal message protocol;
transferring the internal message to an external partition of the server;
converting the message to an external message;
attaching the security token to the external message; and
forwarding the message to the untrusted network with the security token.

7. A secure extranet server for accepting a message received from an untrusted network, the message characterized by a message protocol, the secure extranet server in communication with a trusted network, the secure extranet server comprising:
(a) means for receiving the message in an external partition of the server;
(b) means for verifying the message protocol;
(c) means for converting the message into an internal message, the internal message characterized by an internal message protocol;
(d) means for transferring the internal message to an internal partition of the server;
(e) means for verifying the protocol of the internal message;
(f) means for accepting the message by the secure extranet server;
(g) means for attaching an security token to the internal message; and
(h) means for forwarding the accepted message to the trusted network based on the security token.

8. The secure extranet server of claim 7 further comprising
means for formatting the internal message according to the message protocol of the received message.

9. The secure extranet server of claim 7 further comprising
means for verifying an attached security token if the message is part of an ongoing session.

10. The secure extranet server of claim 7 further comprising
means for dropping the message if the message does not conform to the message protocol.

11. The secure extranet server of claim 7 further comprising
means for dropping the internal message if the internal message does not conform to the internal message protocol.

12. A secure extranet server for sending a message to an untrusted network, the message characterized by a message protocol, the secure extranet server in communication with a trusted network, the secure extranet server comprising:
(a) means for receiving the message in an internal partition of the server;
(b) means for converting the message into an internal message, the internal message characterized by an internal message protocol;
(c) means for transferring the internal message to an external partition of the server;
(d) means for converting the message to an external message;
(e) means for sending the message by the secure extranet server;
(f) means for attaching an security token to the external message; and
(g) means for forwarding the message to the untrusted network.

13. A computer-readable medium having computer-executable instructions for performing a method for accepting a message received from an untrusted network by a secure extranet server in communication with a trusted network, the message characterized by a message protocol, the method comprising:
receiving the message in an external partition of the server;
verifying the message protocol;
converting the message into an internal message, the internal message characterized by an internal message protocol;
transferring the internal message to an internal partition of the server;
verifying the protocol of the internal message;
accepting the message by the secure extranet server;
attaching an security token to the internal message; and
forwarding the accepted message to the trusted network based on the security token.

14. A secure extranet server for restricted access to a resource on a trusted network from an untrusted network, the server comprising:
an adapter for converting a message having a network protocol to and from an internal message having an internal message protocol different from the network protocol;
a filter for verifying the contents of the internal message;
a message application programming interface for transferring the internal message between the adapter and the filter;
a session table configured to hold at least one characteristic of the internal message;
a manager configured to maintain the session table based on a user authorization and the message;
a converter for converting the internal message to and from a trusted message; and
a dispatcher for receiving and forwarding the trusted message to the resource on the trusted network.

15. The server according to claim 14 further comprising:
an external partition in communication with an untrusted network, the external partition configured to convert a message from the untrusted network to an internal message, the message comprising a data field and a message header, the message header comprises at least one characteristic of the message.

16. The server according to claim 14 further comprising:
an internal partition in communication with a trusted network.

17. The server according to claim 16 further comprising:
a message application programming interface configured to pass an internal message between an external partition and an internal partition.

18. The secure extranet server of claim 17 wherein the message application programming interface is configured to pass the internal message between the external partition and the internal partition only upon a request originating from the internal partition.

19. The secure extranet server of claim 17 wherein the message application programming interface is configured to pass the internal message between the external partition and the internal partition upon a request originating from the external partition and wherein the dispatcher forwards the internal message based in part on an security token.

20. A secure extranet server for restricted access to a resource on a trusted network from an untrusted network, the server comprising:
an adapter for converting a message having a network protocol to and from an internal message having an internal message protocol different from the network protocol;
a filter for verifying the contents of the internal message;
a message application programming interface for transferring the internal message between the adapter and the filter;
a session table configured to hold at least one characteristic of the internal message;
a manager configured to maintain the session table based on a user authorization and the message;
a converter for converting the internal message to and from a trusted message;
a dispatcher for receiving and forwarding the trusted message to the resource on the trusted network; and
a file converter for attaching an application cookie to a document controlled by a documentation control platform to enable a remote user outside the trusted network to checkout a file, modify it, and checkin the modified file with the application cookie providing necessary access without multiple signin authentication steps.

21. A method for operating a secure extranet server, the method comprising
a) receiving from a first computer endpoint content description language comprising at least one request for input data and at least one constrain to the expected input data,
b) enriching the content description language sent by the first computer endpoint with at least one security token that is based on the at least one request for input data and comprises at least one constraint to the expected input data,
c) sending to a second computer endpoint content description language enriched with the at least one security token,
d) receiving from the second computer endpoint input data together with the at least one security token,
e) parsing input data and the at least one security token sent by the second computer endpoint,
f) verifying the input data against the at least one constraint determined in the security token, and
g) blocking the transfer of input data which does not conform to the at least one constraint.

22. The method according to claim 21 wherein the system comprises
at least one first computer endpoint comprising at least one Web application server,
at least one second computer endpoint comprising a client computer with a Web browser, and
a secure extranet server that is placed in front of the at least one Web application server in order to protect the at least one server from hacking attempts by client Web browsers.

23. The method according to claim 21 wherein the transferred content description language comprises hypertext markup language content.

24. The method according to claim 23 wherein parsing content description language comprises
extracting attribute information and
creating at least one security token that is based on the extracted attribute information.

25. The method according to claim 24 wherein attribute information comprises name parameters.

26. The method according to claim 24 wherein attribute information comprises universal resource identifiers.

27. The method according to claim 24 wherein attribute information comprises expected data values.

28. The method according to claim 24 wherein attribute information comprises expected value ranges.

29. The method according to claim 24 wherein attribute information comprises expected value types.

30. The method according to claim 24, wherein enriching content description language with the security token, comprises encrypting and preferably digitally signing the security token and after receiving input data and the at least one security token sent by the second computer endpoint, the security service is decrypting and preferably verifying the security token.

31. A computer program comprising program code means for performing all the steps of the method of claim 20 by adapting a computer.

32. A computer program comprising program code means for performing all the steps of the method of claim 20 by adapting a Web application firewall.

33. A computer program comprising program code means for performing all the steps of the method of claim 20 by adapting a reverse Web proxy server.

34. A computer program comprising program code means for performing all the steps of the method of claim 20 by adapting a load balancing appliance.

35. A security service apparatus for Web application security filtering, the apparatus comprising:
a) means for receiving content description language transferred between at least a first and a second computer endpoint through the security service apparatus.
b) means for enriching the content description language sent by the first computer
endpoint with at least one security token that is based on at least one request for input
data and at least one constraint to the expected input data,
c) means for sending to the second computer endpoint content description language
enriched with the at least one security token,
d) means for receiving from the second computer endpoint input data together with the at least one security token,
e) means for parsing input data and the at least one security token sent by the second computer endpoint,
f) means for verifying the input data against the at least one constraint in the security token, and
g) means for blocking the transfer of input data which does not conform to the at least one constraint.
